(19) United States
(12) Patent Application Publication
(10) Pub. No.: US 2003/0198144 A1
(43) Pub. Date: Oct. 23, 2003

(54) Seal to be sticked on the face of clock to indicate time difference

(76) Inventor: Naoki Ohno, Shirone-city (JP)

Correspondence Address: Naoki Ohno, Ohwaza Hishikata 187, Niigata-prefecture, Shirone-city, 950-1443, JP

(21) Appl. No.: 10/126,854

(22) Filed: Apr. 19, 2002

(51) Int. Cl. G04B 19/06; G04C 17/00; G04B 19/00; G04B 25/00; G04B 19/04

(52) U.S. Cl. 368/223

(57) ABSTRACT

A seal to be sticked on the face of clock to indicate time difference in foreign countries comprising indication part on one side thereof and adhesive part of onther side thereof, indication part having three types of graduations to recognize more accurate time difference. Said seals are made clear and transparent and onto a clear clockface cover portion of a clock and easily detached off the clock in no use. A combination ways of said three types of graduations may be employed to recognize more detailed and accurate time difference.

This invention relates generally to a seal to indicate a time with an hour and minute hands, that corresponds to a time difference. In order to remove extra efforts for a time difference such as adjusting a travel watch and/or wristwatch to the regional time at each arrive and depart at foreign countries, and/or calculating the Japan time from the different regional time zone when travel in abroad, my device was made by employing seal sticked on the face of clock that has a hour and minute hands and is made by clear materials such as grasses, plastics and so on, to correspond to a time difference, and it is possible to recognize both domestic and abroad time.

### DESCRIPTION OF THE PRIOR ARTS

Heretofore, there has been several clock styles to correspond and recognize a time difference on those in use. The main products now on display are as follows:

The style has not only regular hour and minute hands but also special hands to correspond to a time difference that can be adjusted and set to the foreign countries' time (as shown by FIG. 12). The other style has not only regular face of clock but also an additional face of clock in order to correspond to a time difference that can be adjusted and set to the foreign countries' time (as shown by FIG. 13).

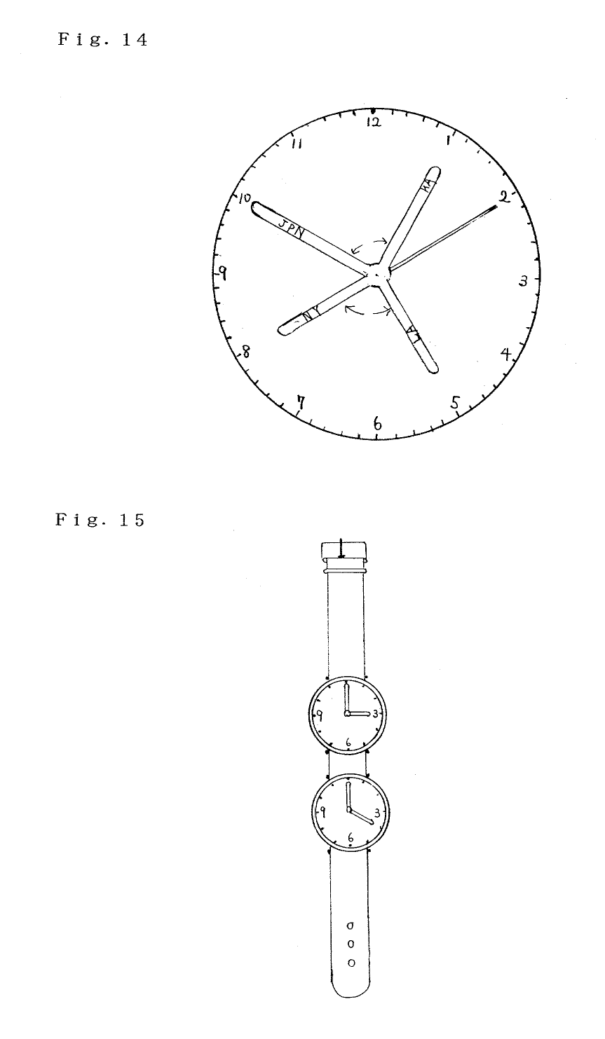

The still more style installs two clocks at one belt (as shown by FIG. 14).

The another one style is a seal to be sticked on the glass part of face of clock (as shown by FIG. 14).

But each above-mentioned product has weak point as follows:

The style shown by FIG. 12 is difficult to recognize the minute level time difference.

The style shown by FIG. 13 is difficult to be produced by using current clock producing technology, hence not marketable.

And, the style shown by FIG. 14 is necessary to calculate a time difference of major countries, and also it is impossible to recognize the minute level time difference.

Still more, those styles shown by FIG. 12 through FIG. 15 are necessary to be made by high level technology, expensive, and need to buy an extra clock for travel in abroad.

The style, that is a seal to be sticked on the glass part of face of clock, as shown by FIG. 15, has weak points namely it is difficult to recognize the exact time at a minute level, and its seal covered the indication part of original face of clock.

Present invention was made to improve above described defects of heretofore used styles of products which my invention pertains.

Other objects and advantages of the invention will become apparent during the following discussion of the accompanying drawings, wherein;

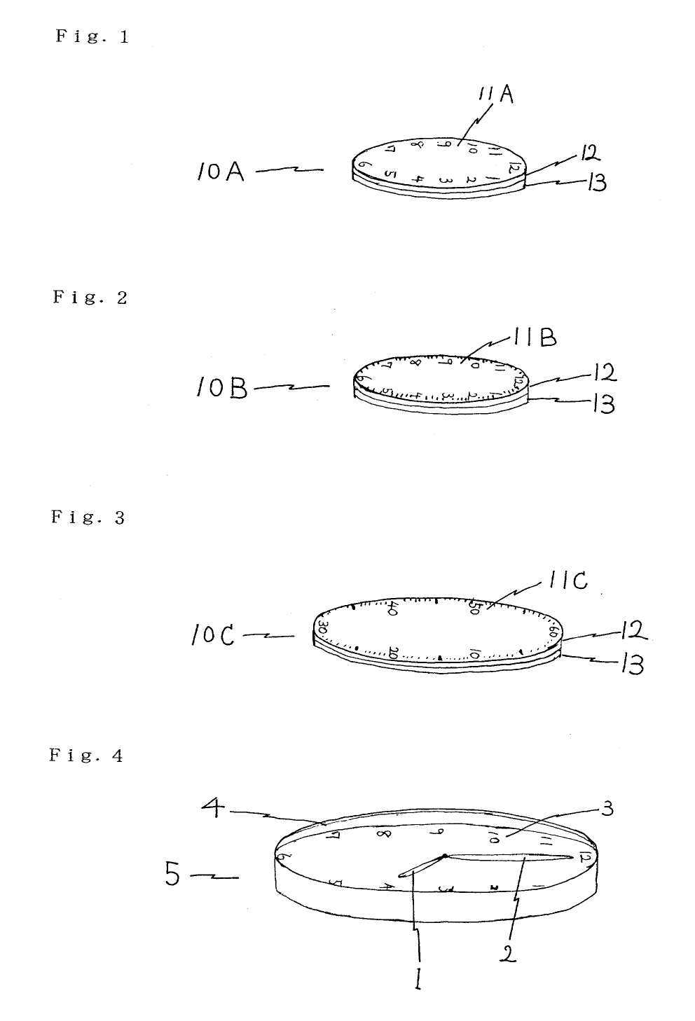

FIG. 1 is a schematic perspective view of a seal for a clock of my invention, a graduations that divided three hundred sixty degrees into twelve equal parts.

FIG. 2 is a schematic perspective view of a seal for a clock of my invention, a graduations that divided three hundred sixty degrees into twelve equal parts, and each twelve equal graduation is divided into six equal parts.

FIG. 3 is a schematic perspective view of a seal for the clock of my invention, in which, graduations that divided three hundred sixty degrees into sixty equal parts.

FIG. 4 is a schematic perspective view of normal clock.

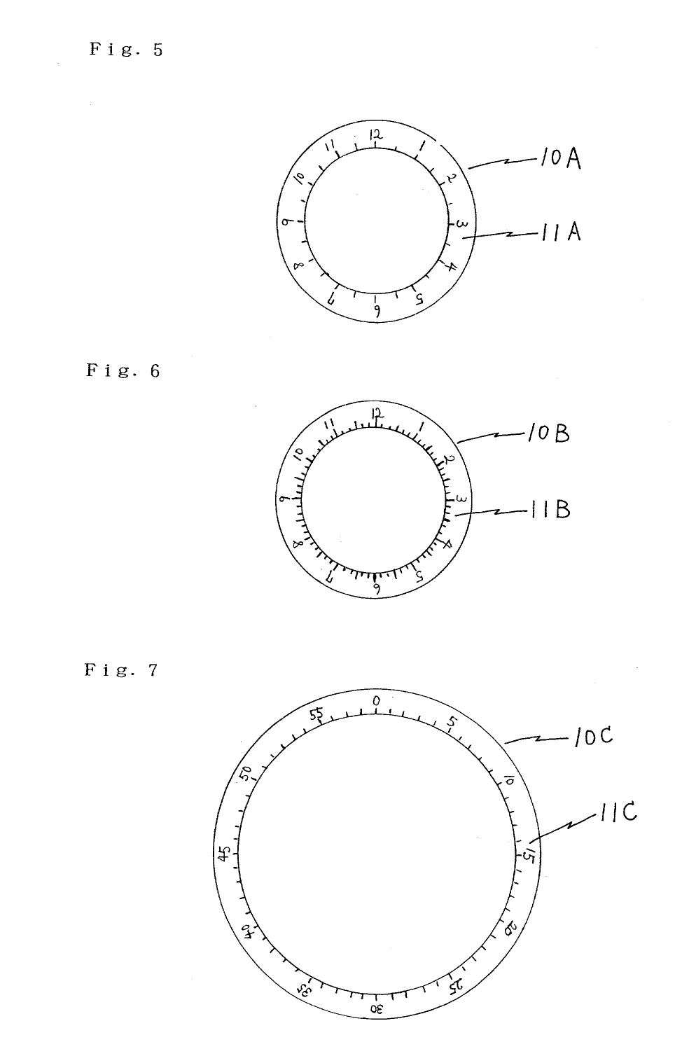

FIG. 5 is a schematic plan view of the clockface of my invention, a graduation that divided three hundred sixty degrees into twelve equal parts.

FIG. 6 is a schematic plan view of the clockface of my invention, a graduation that divided three hundred sixty degrees into twelve equal parts, and each twelve equal graduation is divided into six equal parts.

FIG. 7 is a schematic plan view of the clockface of my invention, a graduation that divided three hundred sixty degrees into sixty equal parts.

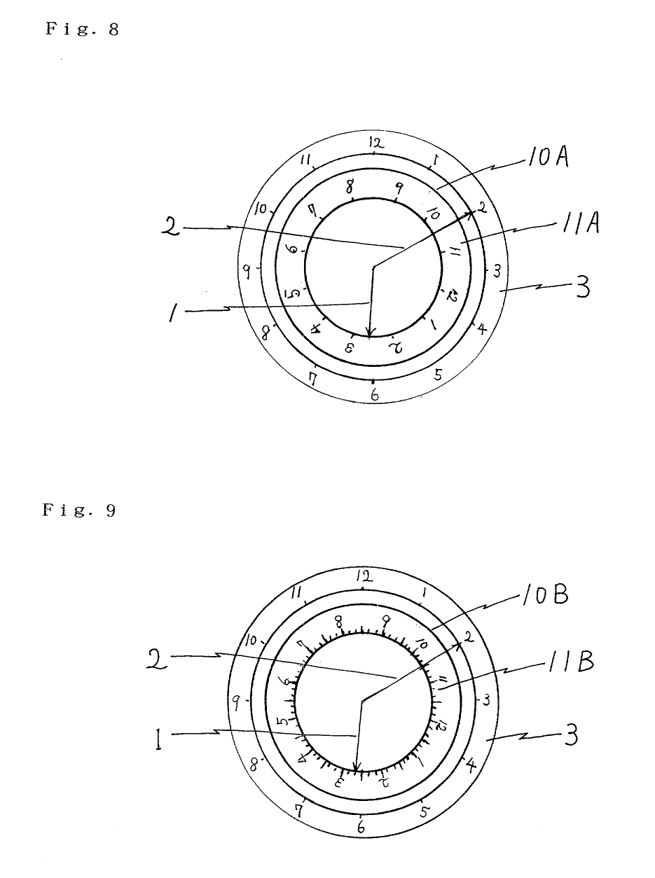

FIG. 8 is a schematic plan view of the clockface of my invention with a normal clockface.

FIG. 9 is a schematic plan view of the clockface of my invention with a normal clockface.

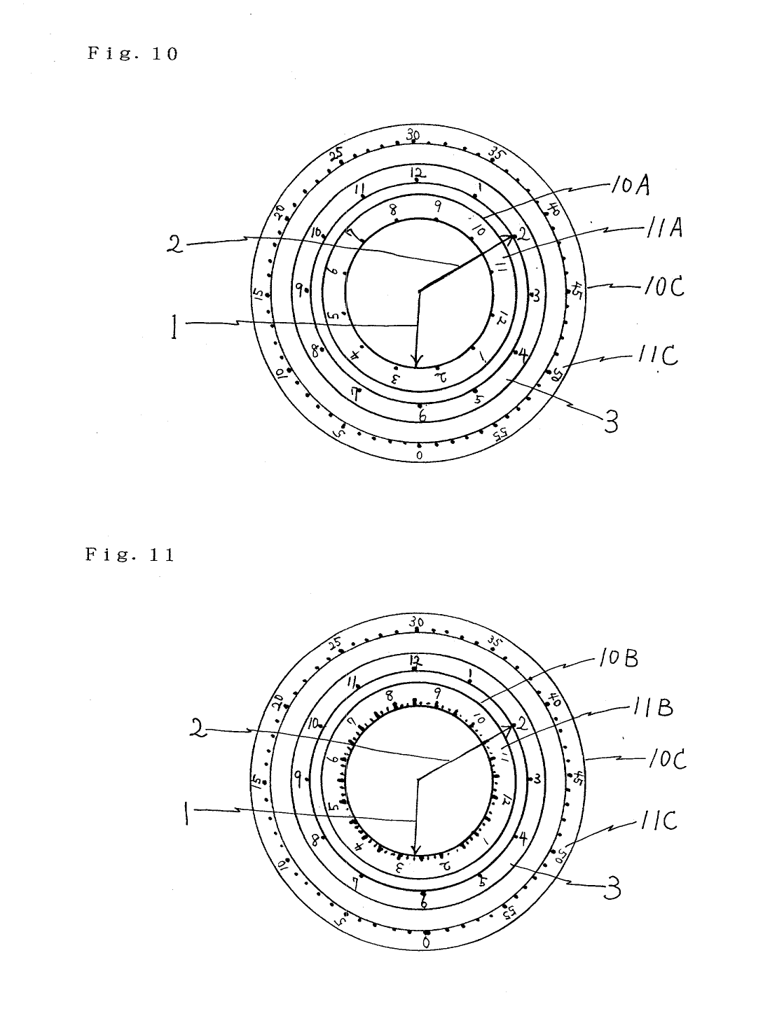

FIG. 10 is a schematic plan view of the clockface of my invention with a normal clockface.

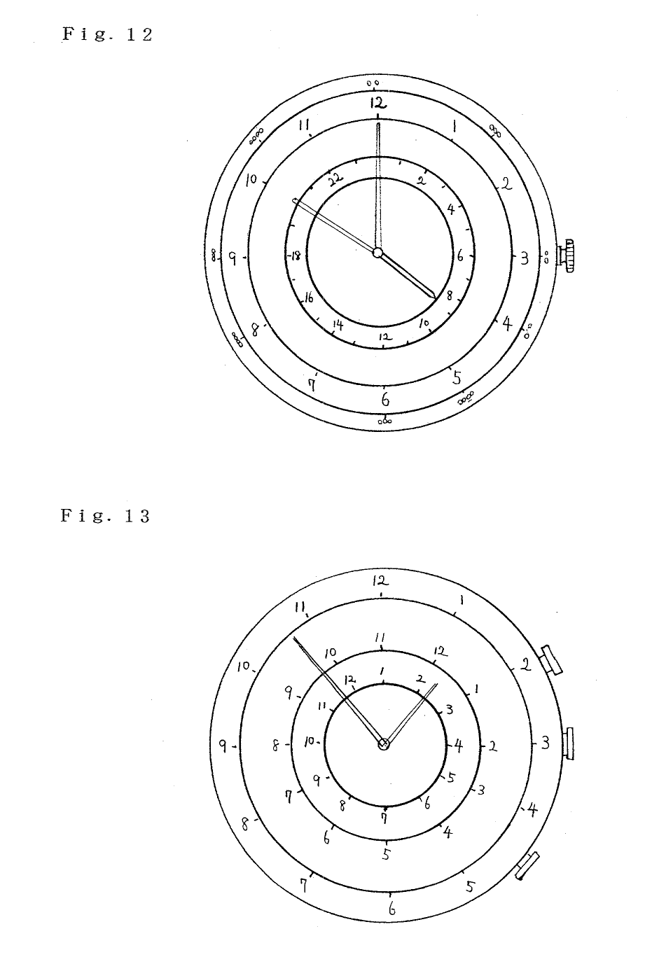

FIG. 11 is a schematic plan view of the clockface of my invention with a normal clockface.

FIG. 12 is a schematic plan view of a clockface that has not only regular hour and minute hands but also special hands to correspond to a time difference that can be adjusted and set to the foreign countries' time.

FIG. 13 is a schematic plan view of a clockface having an additional clockface in order to co-respond to a time differene that can be adjusted to the foreign countries' time.

FIG. 14 is a schematic plan view of a clockface which is equipped with separate hands that can be adjusted to the main foreign countries' time.

FIG. 15 is a schematic plan view of one style that installs two clocks with one belt.

Referential numerals in the drawings;

1—hour hand

2—minute hand

3—clockface

4—clear cover seal

5—clock (watch)

10A—clockface seal

10B—the same as above

10C—the same as above

11A—graduation printed on seal

11B—the same as above

11C—the same as above

12—indicating portion

13—adhesive portion

Steps to solve defects involved in heretofore employed clock styles;

In order to solve aforementioned defects of clocks I presented three types of new devices.

1) To prepare a clear seal composed of indication part (12) and adhesive part (13), said indication part (12) having twelve graduations (11A) printed on said seal by dividing three hundred sixty degrees into twelve equal parts. Thus, one type of THE SEAL TO BE STICKED ON THE FACE OF CLOCK TO INDICATE TIME DIFFERENCE (10A) was deviced.

The directions for use this seal (10A); Set up the adjusted time to a time differene of foreign country, then stick the seal (10A) (FIG. 1) on the clear clockface cover (4) of usual normal clock (5) (in FIG. 4). Then we recognize “about time” by looking the minute hand of said normal clock.

2) To prepare a clear seal composed indication part (12) and adhesive part (13), said indication part (12) having twelve graduation (11A) printed on said seal by dividing three hundred sixty degrees into twelve equal parts, and stillmore, these each twelve equal parts are divided into six equal parts (11B) to show more detail graduations. Thus, another type of THE SEAL TO BE STICKED ON THE FACE OF CLOCK TO INDICATE TIME DIFFERENCE (10B) (FIG. 2) was deviced.

The direction for use this seal (10B); Set up the seal (10B) to the adjusted time to a time difference of foreign country, then stick the seal (10B) (FIG. 2) on the clear clockface cover (4) of usual normal clock (5) (in FIG. 4). Then we can recognize “about time” by looking the minute hand of said normal clock.

This device is similar to the before said device 1), however, there is difference that has more detailed graduations that divided between each twelve graduations into six equal parts in order to be able to recognize a ten minutes unit more accurately (FIG. 2, FIG. 4).

3) To prepare a clear seal composed of indication part (12) and adhesive part 13, said indication part (12) having sixty graduations (11C) printed on said seal by dividing three hundred sixty degrees into sixty equal parts (11C) to shown more detail graduations.

The direction for use this seal (10C) is almost same as device 1) and 2).

This device does no be used independently.

IMPREMENTATION FORM OF THE INVENTION;

Method 1 claimed in claim 1 is related to the stick-style seal (10A) on the front portion of the clock that corresponds to a time difference. The device is made by the indication portion (12) that formed by printed twelve graduations that divided three hundred and sixty degrees into twelve equal parts (11A) on a flexible vinyl or clear thin material such as plastic, and adhesive part (13) that formed by applying an adhesive on the one side of the above said clock face seal (10A). It tells “the about time difference” that the hour hand ((1) of the normal clock indicates one point of twelve graduations that divided three hundred and sixty degrees into twelve equal parts on the seal face of the device by setting the time difference of foreign countries, and sticking the clear clock face cover (4) on the face portion of normal clock (5) having the hour hand (1) and minute hand (2).

Above process can be better understood by FIG. 1, FIG. 4, FIG. 5 and FIG. 8.

Method 2 claimed in claim 2 is related to the stick-style seal on the front portion of the clock that corresponds to a time difference. The device is made by the indication portion (12) that formed by printed twelve graduations that divided three hundred and sixty degrees into twelve equal parts and more detailed graduations that divided portion between each twelve graduations into six equal parts on the face of the flexible binyl or clear thin material sheet such as plastic, and the adhesive part (13) that formed by applying an adhesive on the one side of said clear seal. Then by setting the time difference of foreign countries and sticking the clear cover seal (4) on the clock face (3) of normal clock (5) that formed by the hour hand (1) and minute hand (2) with above-mentioned seal on the face of clock, it tells “the about time difference” with the hour hand (1) indicates one point between twelve equal parts of the seal face of clock.

Further, the meaning of “about time” in here, is related to a unit of time, some o'clock and some minutes almost exactly. In order to recognize a daily time, it is correspondable by using the seal for the face of clock (FIG. 2, FIG. 4, FIG. 6 and FIG. 9).

Method 3 claimed in claim 3 is related to the stick-style seal on the front portion of the clock that corresponds to a time difference.

The device is made by the indication portion (12) that formed by printed sixty graduations that divided three hundred and sixty degrees into sixty equal parts on the face of the seal.

Further, as described before, the seal for the face of clock by this method 3 does not be used alone. It indicates “the exact time difference in minutes” from “the exact time difference” by using the seal for the face of clock, the method in claim 1 or claim 2.

Next, by looking the FIG. 10, let me explain the directions for use both the seal for the face of clock with sixty graduations that diveded three hundred and sixty degrees into sixty equal parts, above mentioned method 3, and the seal for the face of clock with twelve graduations that divided three hundred and sixty degrees into twelve equal parts, the method 1, jointly in order to recognize “the exact time difference”.

Firstly, stick the seal of the face of clock of method 1 with twelve graduations that divived three hundred and sixty degrees into twelve equal part on the original face of clock by setting the seal early and/or back hours to correspond to a time difference in abroad.

FIG. 10 indicates a condition that is three hours and thirty minutes late.

Then stick the seal (10A) of face of clock with sixty graduations by method 3 that divided three hundred and sixty degrees into sixty equal parts on the original face of clock by setting the seal early and/or back minutes to correspond to a time difference in abroad. (FIG. 10 indicates a condition that is three hours and thirty minutes late.)

As a result, the hour hand (1) indicates around two o'clock and thirty minutes to the graduations that divided three hundred sixty degrees into twelve equal parts on the seal for the face of clock. This is the about time difference in concerned foreign cuntry.

As we can see, it is possible to recognize an about time difference by the seal for face of clock and hour hand.

Moreover, in order to recognize more exact time, the minute hand indicates exact forty minutes by sixty graduations that divided three hundred and sixty degrees into sixty equal parts on the face of clock.

It is possible to recognize the exact time, two o'clock and forty minutes, as well as the exact time difference by using two types of face of clock jointly.

Further more, it is possible to recognize both six o'clock and ten minutes in an original country by looking the hour hand and minute hand, in this case, the time difference is three hours and thirty minutes.

At the next, by looking the FIG. 10, let me explain the directions for use both the seal (10C) for the face of clock with sixty graduations that divided three hundred and sixty degrees into sixty equal parts by method 3 and the seal (10A) for the face of clock with twelve graduations that divided three hundred and sixty degrees into twelve equal parts by method 1 jointly in order to recognize “the exact time difference”.

Firstly, stick the seal of the face of clock of method 1 with twelve graduations that divided three hundred and sixty degrees into twelve equal parts on the original face of clock. (The FIG. 10 indicates a condition that is three hours and thirty minutes late).

Also, stick the seal (10C) of the face of clock with sixty graduations of method 3, that divided three hundred and sixty degrees into sixty equal parts on the original cover (4) of clock by setting the seal early and/or back minutes to correspond to a time difference in abroad. (FIG. 10 indicates a condition that is thirty minutes late).

As a result, the hour hand (1) indicates around two o'clock and thirty minutes to the graduation that divided three hundred and sixty degrees into twelve equal parts on the seal for the face of clock. This is the about time difference in concerned foreign country.

As we can see, it is possible to recognize an about time difference by this seal (10A) for the face of clock and hour hand (1).

Moreover, in order to recognize more exact time, the minute hand (2) indicates exact forty minutes by sixty graduations (11C) that divided three hundred and sixty degrees into sixty equal parts on the face of clock.

Furthermore, it is possible to recognize the exact time, two o'clock and forty minutes as well as the exact time difference by using two types of face of clock jointly.

Still more, it is possible to recognize both six o'clock and ten minutes in an original coutry by looking the hour hand (1) and minute hand (2), and the time difference is three hours and thirty minutes.

Also, FIG. 10 and FIG. 11 mention the seal of method 3 in the outskirts of the original face of clock, however, it is possible to set up on the internal circulation of the original face of the clock.

Also, the shape for seals that mentioned from method 1 to method 3 are all disk shapes in these fugures. In this case, the direction is; lay two seals on top or another, and stick these seals on the cover of the face of clock.

However, the shape of seal is not necessary to be the disk shape. For example, it is possible to stamp out the method 3′'s seal to a doughnut shape.

In addition, it is also possible to reduce manufacturing processes.

The effect of the device; The seals by this device are stickable to any regular clocks that have hour hand and minute hand in order to tick a time.

It is easy to stick the seal on a clock as FIGS. 8 to 11 show, as well as, to recognize a time difference.

It is fine to use a clock with sticking seal for a regular domestic clock.

It is possible to tear off the seal easily, and recyclable to re-use.

The product materials and manufacturing process are same as regular used stick type seals, therefore, it is possible to produce with low cost, and it is uncecessary to invest money for new equipment.

What I claim is:

1) A seal to be s ticked on the face of clock to indicate time difference, wherein the seal is made clean and transparent having graduation on one face thereof and other face is made adhesive to be sticked on a clockface cover portion of the clock, said graduation that divided three hundred sixty degrees into twelve equal parts,

2) A seal as claimed in claim 1, wherein the each twelve equal graduation is divived into six equal parts,

3) A seal as claimed in claims 1 and 2, wherein the graduation that divided three hundred sixty degrees into sixty eqaul parts to shown more detail graduation,

4) A seal as claimed in claims 1, 2 and 3, wherein a means of adjusting the time to time difference of a foreign country, a means of sticking said seal on the clear clockface cover of a clock to recognize the time difference of said country,

5) A seal as claims in claim 1 to 3, wherein a means of recognizing more accurate time difference in one country by using the seal claimed in claim 1 and 2, a means of using the seal claimed in claim 1 and 3, a means of using the seal claimed in claim 1, 2, and 3.
